(19) United States
(12) Patent Application Publication
(10) Pub. No.: US 2007/0238510 A1
(43) Pub. Date: Oct. 11, 2007

(54) Wagering game with symbol animation on moving reels

(75) Inventor: James Halprin, Balmain (AU)

Correspondence Address: NIXON PEABODY LLP, 161 N CLARK ST., 48TH FLOOR, CHICAGO, IL, 60601-3213, US

(73) Assignee: WMS Gaming, Inc.

(21) Appl. No.: 11/399,268

(22) Filed: Apr. 5, 2006

(51) Int. Cl. A63F 13/00

(52) U.S. Cl. 463/20

(57) ABSTRACT

A gaming machine for playing a wagering game is provided according to one embodiment of the present invention. The gaming machine includes a value input device which may receive a wager. The gaming machine also includes a display region for displaying an array of symbols. The symbols indicate a randomly selected outcome of the wagering game. The randomly selected outcome is selected from a plurality of outcomes including at least one winning outcome. At least one of the symbols is an advantageous symbol that indicates the potential for completing a winning outcome, resulting in an award. The at least one advantageous symbol in the array is animated as it moves through the display region.

### FIELD OF THE INVENTION

The present invention relates generally to gaming machines and methods for playing wagering games, and more particularly to a gaming machine and a method of playing a wagering game having symbol animation on moving reels.

### BACKGROUND OF THE INVENTION

Gaming machines, such as slot machines, video poker machines and the like, have been a cornerstone of the gaming industry for years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and, hence, increase profitability to the operator. Therefore, there is a continuing need for gaming machine manufacturers to continuously develop new games and improved gaming enhancements that attract frequent play through enhanced entertainment value to the player.

In one type of games, sounds are used for creating anticipation in a player. For example, the gaming machine makes a sound as each trigger symbol (i.e., pre-determined symbol) lands in the display area. The sound indicates that a bonus game is getting closer. In another type of games, all the trigger symbols are animated after all the reels have stopped. In yet another type of games, trigger symbols become animated after they have stopped spinning. In still yet another type of games, certain symbols are made larger than their typical size, resulting in an overlap with symbols above and below. These larger symbols are static images that are displayed and are not added under certain conditions.

One problem with current games is the lack of visual anticipation on the reel as it moves through the display area. Thus, in current games the player's visual sense is not fully enhanced as the spinning reels move through the display area because an advantageous symbol, such as one that could result in a payout, is not visually differentiated from the non-advantageous symbols.

Accordingly, there is a continuing need to develop gaming machines that address the above-described issue.

### SUMMARY OF THE INVENTION

A gaming machine for playing a wagering game is provided according to one embodiment of the present invention. The gaming machine includes a value input device which receives a wager. The gaming machine also includes a display region for displaying an array of symbols. The symbols indicate a randomly selected outcome of the wagering game. The randomly selected outcome is selected from a plurality of outcomes including at least one winning outcome. At least one of the symbols is an advantageous symbol that indicates the potential for completing a winning outcome, resulting in an award. The at least one advantageous symbol in the array is animated as it moves through the display region.

A method of conducting a wagering game on a gaming machine is also provided. The method includes the act of receiving a wager input. The method also includes the act of displaying an array of symbols in a display region. The symbols indicate a randomly selected outcome of the wagering game. The randomly selected outcome is selected from a plurality of outcomes including at least one winning outcome. At least one of the symbols is an advantageous symbol that indicates the potential for completing the winning outcome resulting in an award. The method further comprises the act of animating the at least one advantageous symbol on the array as the advantageous symbol moves through the display region.

In another embodiment of the present invention, a method of conducting a wagering game on a gaming machine is disclosed. The method includes the act of receiving a wager input. The method further includes the act of displaying spinning reels having symbols thereon, whereby the symbols indicate a randomly selected outcome of the wagering game. The randomly selected outcome includes at least one winning outcome. The winning outcome is indicated by a winning symbol combination having at least a first winning symbol and a second winning symbol. The method also includes the act of stopping at least one of the reels with the first winning symbol on an active payline. While another reel is spinning, the method further includes the act of animating the second winning symbol as the second winning symbol moves adjacent to the active payline.

Additional aspects of the invention are apparent to those of ordinary skill in the art in view of the detailed description of various embodiments, made with reference to the drawings, a brief description of which is provided below.

### BRIEF DESCRIPTION OF THE DRAWINGS

FIG. 1 is a perspective view of a gaming machine according to one embodiment of the present invention.

FIG. 2 is a block diagram of the gaming machine of FIG. 1.

FIG. 3 illustrates a basic game screen showing a plurality of reels while they are spinning.

FIG. 4 illustrates the basic game screen of FIG. 3 showing two of the reels stopped.

FIG. 5 illustrates the basic game screen of FIG. 3 showing three of the reels stopped.

FIG. 6a illustrates an un-animated advantageous symbol according to one embodiment of the present invention.

FIG. 6b illustrates an animation of the symbol of FIG. 6aaccording to one embodiment.

FIG. 6c illustrates an alternative animation of the advantageous symbol of FIG. 6a.

FIG. 6d illustrates an additional animation of the advantageous symbol of FIG. 6a.

FIG. 6e illustrates an animation of the symbol of FIG. 6aaccording to another embodiment.

FIG. 6f illustrates yet another animation of the symbol of FIG. 6a.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

While this invention is susceptible of embodiment in many different forms, there is shown in the drawings and is herein described in detail preferred embodiments of the invention with the understanding that the present disclosure shall be considered as an exemplification of the principles of the invention and is not intended to limit the broad aspect of the invention to the embodiments illustrated.

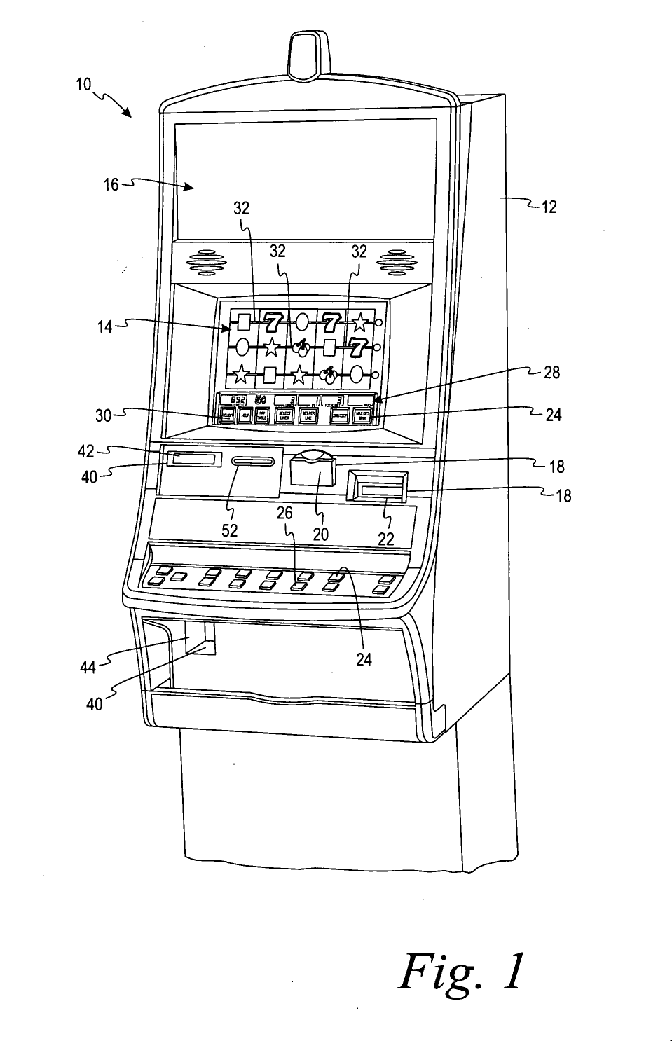

Referring to FIG. 1, a gaming machine 10 is used in gaming establishments such as casinos. With regard to the present invention, the gaming machine 10 may be any type of gaming machine and may have varying structures and methods of operation. For example, the gaming machine 10 may be an electromechanical gaming machine configured to play mechanical slots, or it may be an electronic gaming machine configured to play a video casino game, such as blackjack, slots, keno, poker, blackjack, roulette, etc.

The gaming machine 10 comprises a housing 12 and includes input devices, including a value input device 18 and a player input device 24. For output, the gaming machine 10 includes a primary display 14 for showing information about the basic wagering game. The primary display 14 can also show information about a bonus wagering game and a progressive wagering game. The gaming machine 10 may also include a secondary display 16 for showing game events, game outcomes, and/or signage information. While these typical components found in the gaming machine 10 are described below, it should be understood that numerous other elements may exist and may be used in any number of combinations to create various forms of a gaming machine 10.

The value input device 18 may be provided in many forms, individually or in combination, and is preferably located on the front of the housing 12. The value input device 18 receives currency and/or credits inserted by a player. The value input device 18 may include a coin acceptor 20 for receiving coin currency (see FIG. 1). Alternatively, or in addition, the value input device 18 may include a bill acceptor 22 for receiving paper currency. Furthermore, the value input device 18 may include a ticket reader, or barcode scanner for reading information stored on a credit ticket, a card, or other tangible portable credit storage device. The credit ticket or card may also authorize access to a central account, which can transfer money to the gaming machine 10.

The player input device 24 comprises a plurality of push buttons 26 on a button panel for operating the gaming machine 10. In addition, or alternatively, the player input device 24 may comprise a touch screen 28 mounted by adhesive, tape, or the like over the primary display 14 and/or secondary display 16. The touch screen 28 contains soft touch keys 30 denoted by graphics on the underlying primary display 14 and used to operate the gaming machine 10. The touch screen 28 provides players with an alternative method of input. A player enables a desired function either by touching the touch screen 28 at an appropriate touch key 30 or by pressing an appropriate push button 26 on the button panel. The touch keys 30 may be used to implement the same functions as push buttons 26. Alternatively, the push buttons 26 may provide inputs for one aspect of the operating the game, while the touch keys 30 may allow for input needed for another aspect of the game.

The various components of the gaming machine 10 may be connected directly to, or contained within, the housing 12 as seen in FIG. 1, or may be located outboard of the housing 12 and connected to the housing 12 via a variety of different wired or wireless connection methods. Thus, the gaming machine 10 comprises these components whether housed in the housing 12, or outboard of the housing 12 and connected remotely.

The operation of the basic wagering game is shown to the player on the primary display 14. The primary display 14 can also show the bonus game associated with the basic wagering game. The primary display 14 may take the form of a cathode ray tube (CRT), a high resolution LCD, a plasma display, an LED, or any other type of display suitable for use in the gaming machine 10. As shown, the primary display 14 includes the touch screen 28 overlaying the entire monitor (or a portion thereof) to allow players to make game-related selections. Alternatively, the primary display 14 of the gaming machine 10 may include a number of mechanical reels to display the outcome in visual associated to at least one payline 32. In the illustrated embodiment, the gaming machine 10 is an “upright” version in which the primary display 14 is oriented vertically relative to the player. Alternatively, the gaming machine may be a “slant-top” version in which the primary display 14 is slanted at about a thirty-degree angle towards the player of the gaming machine 10.

A player begins play of the basic wagering game by making a wager via the value input device 18 of the gaming machine 10. A player can select play by using the player input device 24, via the buttons 26 or the touch screen keys 30. The basic game consists of a plurality of symbols arranged in an array, and includes at least one payline 32 indicating one or more outcomes of the basic game; such outcomes are randomly selected in response to the wagering input by the player.

In some embodiments, the gaming machine 10 may also include a player information reader 52 allowing for identification of a player by reading a card with information indicating his or her true identity. The player information reader 52 is shown in FIG. 1 as a card reader, but may take on many forms including a ticket reader, bar code scanner, RFID transceiver, or computer readable storage medium interface. Currently, casinos use this identification for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 52, allowing the casino's computers to register that player's wagering at the gaming machine 10. The gaming machine 10 may use the secondary display 16 or other dedicated player-tracking display for providing the player with information about his or her account or other player-specific information. Also, in some embodiments, the information reader 52 may be used to restore game assets that the player achieved and saved during a previous game session.

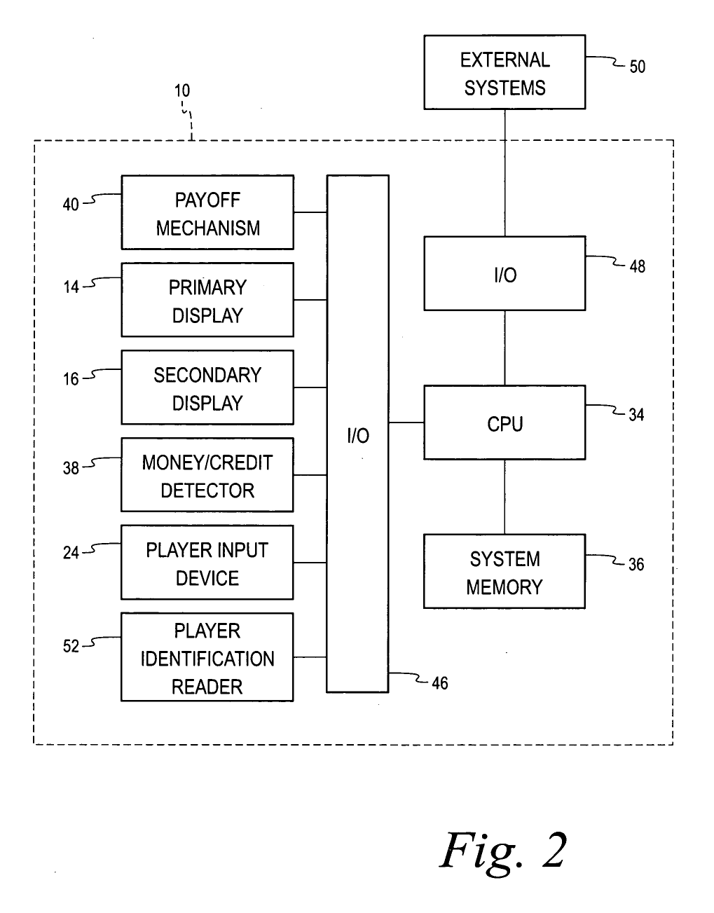

Turning now to FIG. 2, the various components of the gaming machine 10 are controlled by a central processing unit (CPU) 34, also referred to herein as a controller or processor (such as a microcontroller or microprocessor). To provide gaming functions, the controller 34 executes one or more game programs stored in a computer readable storage medium, in the form of memory 36. The controller 34 performs the random selection using a random number generator (RNG) of an outcome from the plurality of possible outcomes of the wagering game. Alternatively, the random event may be determined at a remote controller. The remote controller may use either an RNG or a pooling scheme for its central determination of a game outcome. It should be noted that the controller 34 may include one or more microprocessors, including but not limited to a master processor, a slave processor, and a secondary or parallel processor.

The controller 34 is also coupled to the system memory 36 and a money/credit detector 38. The system memory 36 may comprise a volatile memory (i.e., a random-access memory [RAM]) and a non-volatile memory (i.e., an EEPROM). The system memory 36 may include multiple RAM and multiple program memories. The money/credit detector 38 signals the processor that money and/or credits were input via the value input device 18. Preferably, these components are located within the housing 12 of the gaming machine 10. However, as explained above, these components may be located outboard of the housing 12 and connected to the remainder of the components of the gaming machine 10 via a variety of different wired or wireless connection methods.

As seen in FIG. 2, the controller 34 is also connected to, and controls, the primary display 14, the player input device 24, and a payoff mechanism 40. The payoff mechanism 40 is operable in response to instructions from the controller 34 to award a payoff to the player in response to certain winning outcomes that might occur in the basic game or the bonus game(s). The payoff may be provided in the form of points, bills, tickets, coupons, cards, etc. For example, in FIG. 1, the payoff mechanism 40 includes both a ticket printer 42 and a coin outlet 44. However, any of a variety of payoff mechanisms 40 well known in the art may be implemented, including cards, coins, tickets, smartcards, cash, etc. One or more pay tables stored in the system memory 36 determine the payoff amounts distributed by the payoff mechanism 40.

Communications between the controller 34 and both the peripheral components of the gaming machine 10 and external systems 50 occur through input/output (I/O) circuits 46, 48. More specifically, the controller 34 manages and receives inputs from the peripheral components of the gaming machine 10 through the input/output circuits 46. Further, the controller 34 communicates with the external systems 50 via the I/O circuits 48 and a communication path (i.e., serial, parallel, IR, RC, 10bT, etc.). The external systems 50 may include a gaming network, other gaming machines, a gaming server, communications hardware, or a variety of other interfaced systems or components. Even though the I/O circuits 46, 48 may be shown as a single block, it should be noted that each of the I/O circuits 46, 48 may include a number of different types of I/O circuits.

Controller 34, as used herein, comprises any combination of hardware, software, and/or firmware that may be disposed or reside inside and/or outside the gaming machine 10 that may communicate with and/or control the transfer of data between the gaming machine 10 and a bus, another computer, processor, or device and/or a service and/or a network. The controller 34 may comprise one or more controllers or processors. In FIG. 2, the controller 34 in the gaming machine 10 is depicted as comprising a CPU, but the controller 34 may alternatively comprise a CPU in combination with other components, such as the I/O circuits 46, 48 and the system memory 36.

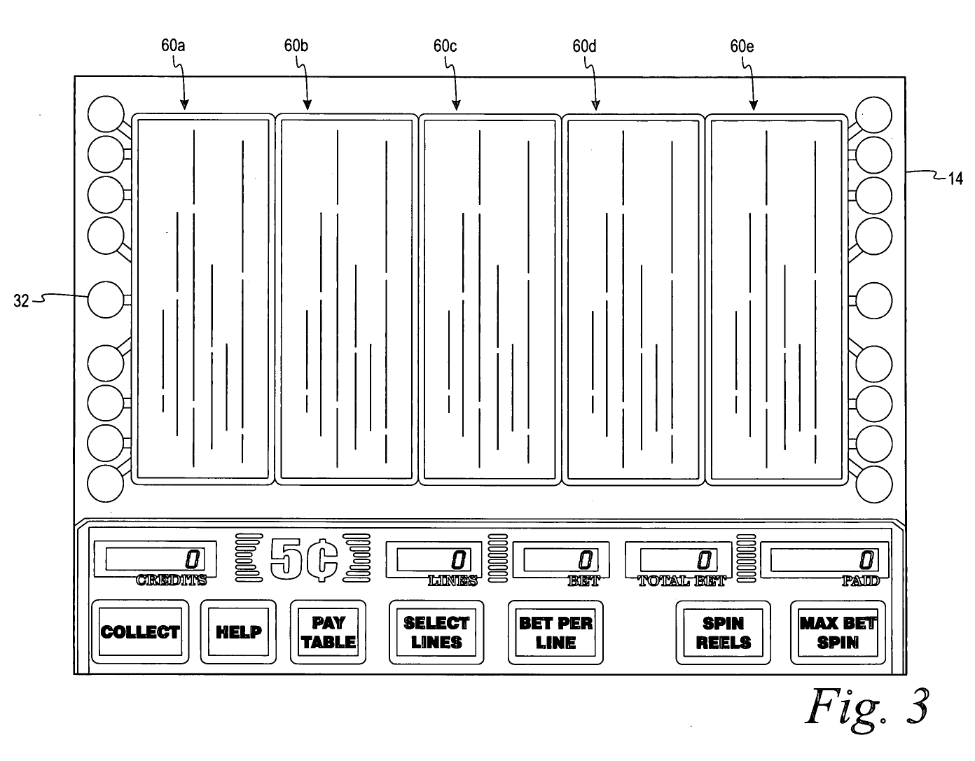

Referring now to FIG. 3, the primary display 14 of the gaming terminal 10 shows reels 60a-60e, which are spinning, and the plurality of paylines 32. Each time the player places a wager in a basic game and spins the reels 60a-60e, there is an inherent hope that the player will win an award. The various awards that can be won include, but are not limited to, monetary awards, non-monetary awards, bonus games and progressive awards. Some non-limiting examples of non-monetary awards include discounts on or complimentary meals, entertainment, telecommunications services, hotels rooms, etc. To build a player'santicipation, which generally translates into a more entertaining gaming experience, it is desirable to provide the player with visual hints that an award is getting closer. Thus, a visual animation of at least one advantageous symbol may visually demonstrate to the player how close he or she is to winning an award. The advantageous symbol(s) is included in the plurality of symbols on the reels 60a-60e.

In general, the reels 60a-60estop in sequence, one at a time, starting with the leftmost reel 60a and ending with the rightmost reel 60e. As each one of the reels 60a-60estops, the player can see the symbol on the reel that has landed on the active payline(s). In general, the presence of one or more advantageous symbols indicates that a winning combination may be completed. Winning combinations trigger awards, such as a monetary award, a non-monetary award, or a bonus or progressive game. However, the mere presence of an advantageous symbol in the display region does not, in and of itself, indicate that an award has been or will be won. Regardless of how many advantageous symbols are required to win an award, the player must wait until the predetermined number of advantageous symbols is displayed to find out whether an award has been won. To entertain the player during this waiting period, the present invention provides a visual animation of the advantageous symbol on the reel before it comes to a stop.

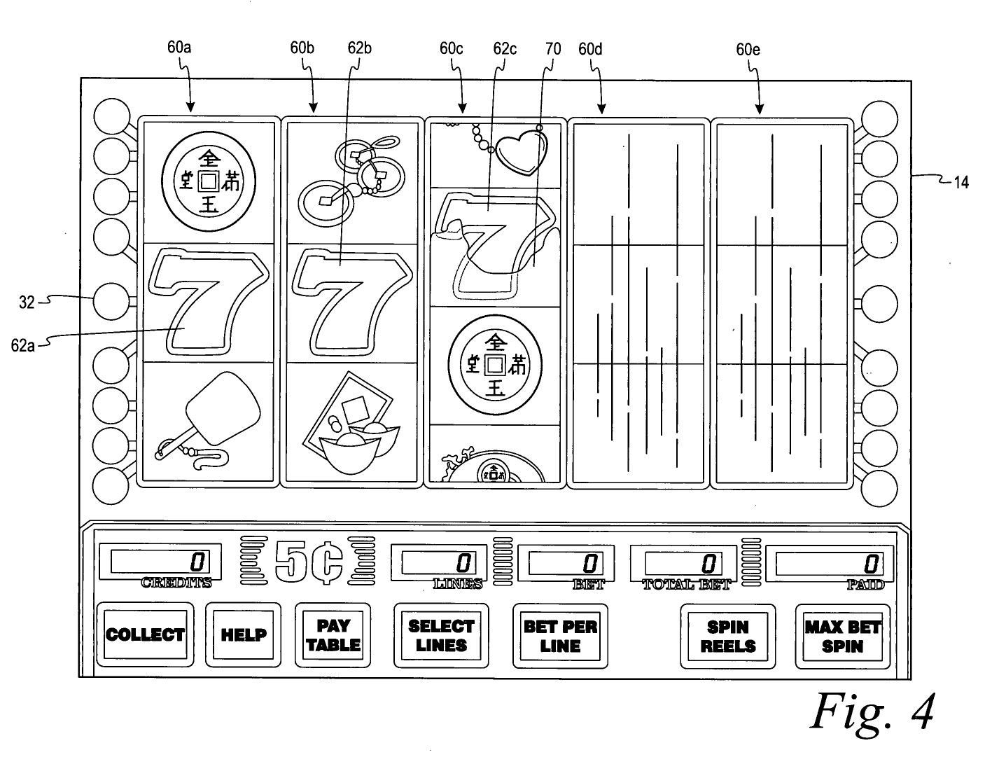

In one embodiment of the present invention, the player plays the basic game and all the reels 60a-60e are spinning, as shown in FIG. 3. For example purposes only, it is assumed that the only active payline is the payline 32 extending across the central position of the reels. Referring now to FIG. 4, the leftmost reel 60a and its adjacent reel 60b have stopped and the landed along the payline 32. A second “7” symbol 62b on the reel 60bthat landed on the payline 32 is an advantageous symbol because it indicates the possibility of completing a winning combination. As the next reel 60c is spinning and begins to stop, the CPU 30 is programmed to display a visual animation of an advantageous “7” symbol 62con the reel 60c before it stops. The visual animation illustrated in this embodiment is a translucent tail 70 preceding the “7 ” symbol 62c. The translucent tail 70 can be of various colors, sizes, shapes, or locations (generally within or surrounding the symbol frame). The translucent tail 70 may also dynamically change colors, sizes, shapes and locations while the reel 60c is moving through the display. In one embodiment, the background of the “7” symbol 62c is white, the “7” symbol 62c is black, and the translucent tail 70 is neon green to highlight the advantageous symbol as it is spinning. Furthermore, the visual animation should not be limited to the translucent tail 70 as disclosed, but may include any visual animation that differentiates the advantageous symbol from the other symbols.

It should be understood, however, that an advantageous symbol in this embodiment would be any “7” symbol along the payline 32 on the reels 60b-60e so long as the reel 60a stops on a “7” symbol and all the successive preceding reels also stop on a “7” symbol so as to potentially complete a winning combination. Thus, an advantageous symbol appears not only to signify the possibility of completing a winning combination, but may also appear to signify the possibility of improving a winning combination to a better winning combination. For example, if the reels 60a-60d have stopped on a “7” symbol in the payline 32 (indicating a “four 7s ” winning combination), the “7” symbol on the reel 60e is an advantageous symbol and may be visually animated while the reel 60e is spinning (to signify the possibility of achieving a “five 7s” winning combination). In contrast, if the reels 60a-60c have stopped on a “7” symbol and the reel 60d has stopped with a different symbol, a “7” symbol on the reel 60e would not be an advantageous symbol because it would not complete a winning combination in a normal pay table arrangement. However, as noted above, even if a symbol on a spinning reel is an advantageous symbol and thus visually animated, it is not necessarily true that an award will be won. For example, if the reel 60alands on a “7” symbol, and subsequently, the reels 60b-60d also land on a “7” symbol, each “7” symbol on the reels 60b-60dwould be animated before each respective reel 60b-60d comes to a stop. However, while the “7” symbol on the reel 60e would be an advantageous symbol and therefore visually animated before the reel 60e comes to a stop, the winning combination may not be completed. Nonetheless, the player has been entertained during the waiting period by this animation of the advantageous symbol.

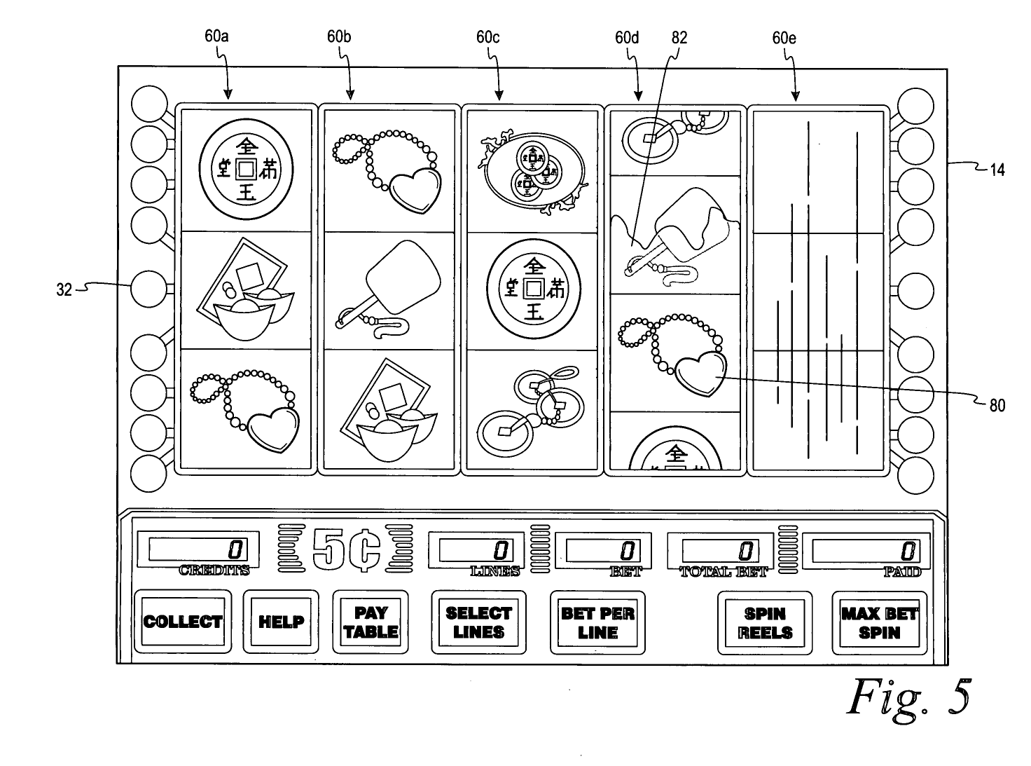

In another embodiment, the visual animation feature is shown in FIG. 5 as used in a scatter payout. A scatter payout occurs when a pre-determined number of designated scatter symbols appear in the display window 14 of the gaming terminal 10 without regard to paylines. In the illustrated embodiment, a scatter payout occurs when three or more heart necklace symbols 80 appear in the display window 14. As the reel 60d is spinning, the heart necklace 80 becomes visually animated as it passes through the primary display 14. Thus, the heart necklace 80 is an advantageous symbol because two heart necklace symbols have appeared on the first two reels 60a, 60b and the third heart necklace 80 (on reel 60d) has the possibility of completing the scatter pay. The visual animation in this embodiment is a translucent tail 82 that follows the symbol frame of the heart necklace 80 as it passes through the primary display area 14. As mentioned above, the visual animations can take various forms and in this case, the translucent tail 82 follows the symbol frame of the heart necklace 80 as opposed to preceding the symbol within the symbol frame as in the previously-described embodiment in relation to FIG. 4. While the translucent tail 82 resembles the previously-described translucent tail, the translucent tail 82 can be of a different color (e.g., blue), appear on the side of the symbol or symbol frame (as opposed to top or bottom), take on a specific shape, or any other reasonable variation which can be imagined.

The visual animations of the advantageous symbols described above in reference to FIG. 4 and FIG. 5 relate to different ways an award may be won. It should be noted, however, that the invention includes the visual animation of any advantageous symbol (i.e., a symbol which indicates the possibility of completing a winning combination) that passes through the primary display 14 while the reels 60 are spinning regardless of the way an award can be won (e.g., line pay, scatter pay, single symbol pay) or the type of award (e.g., bonus game, progressive game, monetary award). Furthermore, although the visual animation described above refers to the primary display 14, the visual animation can nonetheless occur in the secondary display 16 or any other display of the gaming machine 10 in which symbols are on moving reels.

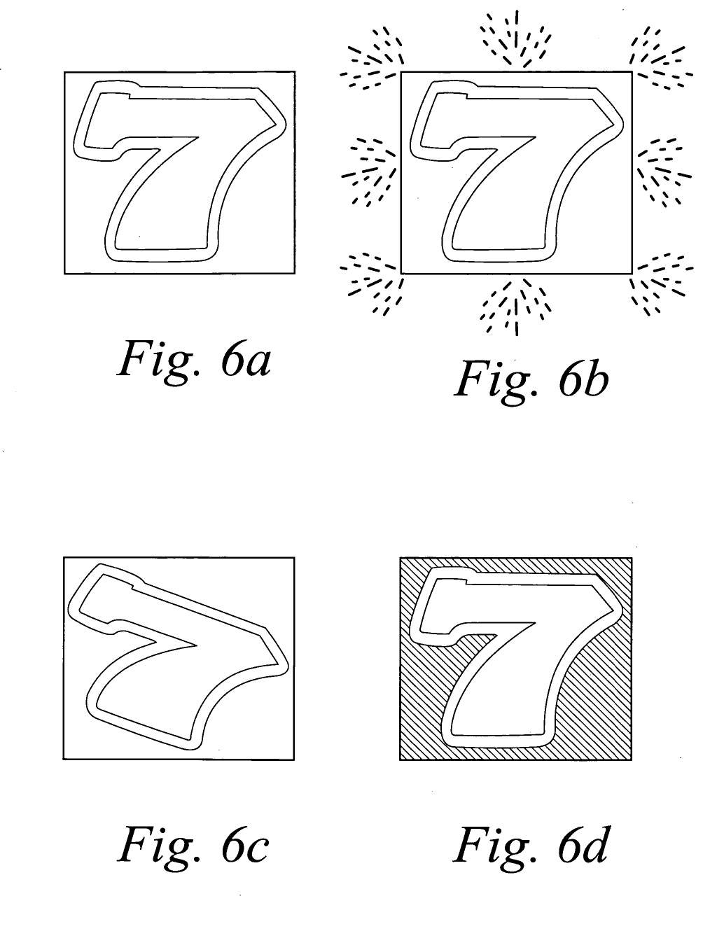

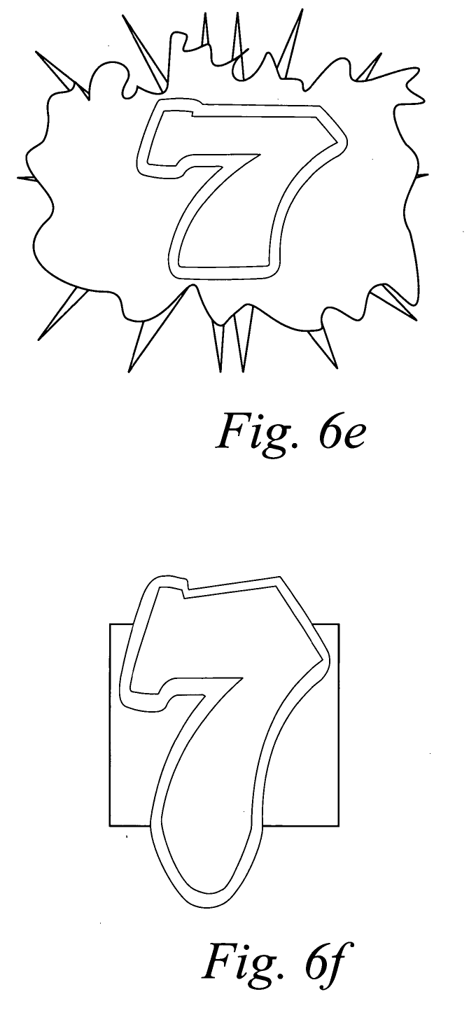

Referring now to FIGS. 6a-6f, various types of visual animations are shown. FIG. 6a shows the un-animated “7” symbol, while FIGS. 6b-6f show variations in the types of visual animations that may occur.

In FIG. 6b, the “7” symbol, as visually animated, is shown with sparks flying off the sides as if the wheels of a train were spewing sparks off the edges of the tracks. The sparks can come off in any direction, be in any color, include more or less sparks, etc. Furthermore, the sparks may also be internal to the “7” symbol resembling firework explosions.

FIG. 6c illustrates internal symbol movement changes. Here, the “7” symbol itself is rotating clockwise as the reel moves through the display. Alternatively, the “7” symbol could rotate counter-clockwise. The symbol in this embodiment may vary in color, brightness, size, functionality, speed at which it rotates, direction in which it rotates, and other similar visual animations. In an alternative internal symbol movement change embodiment, the “7” symbol can be animated to appear as if the “7” symbol is dancing.

In FIG. 6d, the background of the “7” symbol has been visually animated. While the background of the “7” symbol is shown shaded, there are numerous possibilities of what may be done to visually animate the background. For example, in one embodiment, the background could simply be a different color from the symbol. In another embodiment, the background may include moving animations, such as shooting stars for example. Additionally, the background may include dynamic color changes, brightness changes, or any other reasonable animation.

The border of the “7” symbol in FIG. 6e is shown enlarged and distorted. The border may be a contrasting color from the symbol and the surrounding symbols to further differentiate the advantageous symbol. Furthermore, the color of the border may dynamically change as the reel spins or may enlarge and retract as the reel spins. It is also contemplated that the border may extend into the frames of adjacent symbols.

FIG. 6f illustrates the “7” symbol enlarged from its original size. The symbol may expand outside its respective area in this embodiment. The symbol may perhaps enlarge and then retract slightly, back to its original size, or smaller. The symbol may dynamically change colors or shake as if experiencing tremors from an earthquake. All the animations described thus far can be utilized separately or in combination with one or more other types of animations where feasible.

The types of visual animation should not be limited to those disclosed thus far and the invention intends to include any type of visual animation that visually alters the area generally surrounding and/or including a pre-determined symbol as it passes through the display before the reel comes to a stop. Furthermore, although the “7” symbol has been used in the above described embodiments to illustrate visual animation of advantageous symbols, the visual animation can occur on any type of advantageous symbol used in the gaming machine 10.

In some embodiments, sounds may be used in conjunction with the visual animations as described herein to further increase the excitement and/or anticipation of obtaining a winning combination. In additional embodiments, specific symbols may be associated with specific animations. For example, in one basic game, the translucent tail 82 is the animation consistently associated with the heart necklace symbol 80 (shown in FIG. 5) and internal symbol movement is the animation consistently associated with the “7” symbol. In other embodiments, specific animations (e.g., sparks, symbol enlargement) may be consistently associated with specific payouts (e.g., scatter pay, line pay).

While the present invention has been described with reference to one or more particular embodiments, those skilled in the art will recognize that many changes may be made thereto without departing from the spirit and scope of the present invention. For example, the present invention contemplates the ability to visually animate symbols on mechanical reels as well. In one embodiment, lights can be provided behind the pre-determined (advantageous) symbol which may assist in emphasizing a visual animation. The lights can be different colors, varying brightness, may blink at different rates, etc. Each of these embodiments and obvious variations thereof is contemplated as falling within the spirit and scope of the claimed invention, which is set forth in the following claims.

What is claimed is:

1. A gaming machine for playing a wagering game, comprising:
a value input device for receiving a wager;
a display region displaying an array of symbols, the symbols indicating a randomly selected outcome of the wagering game, the randomly selected outcome being selected from a plurality of outcomes including at least one winning outcome, at least one of the symbols being an advantageous symbol that indicates the potential for completing the at least one winning outcome; and
wherein the at least one advantageous symbol in the array is animated as the advantageous symbol moves through the display region.

2. The gaming machine of claim 1, wherein the award is selected from the group consisting of a bonus game, a progressive game, a monetary award, and a non-monetary award.

3. The gaming machine of claim 1, wherein the at least one advantageous symbol completes a winning symbol combination that comprises the at least one winning outcome appearing along an active payline.

4. The gaming machine of claim 1, wherein the at least one advantageous symbol is a scatter symbol.

5. The gaming machine of claim 1, wherein the at least one advantageous symbol moves through the display region without completing the at least one winning outcome.

6. The gaming machine of claim 1, wherein the animation of the at least one advantageous symbol precedes the at least one advantageous symbol.

7. The gaming machine of claim 1, wherein the animation of the at least one advantageous symbol includes internal symbol movement.

8. The gaming machine of claim 1, wherein the animation of the at least one advantageous symbol includes a translucent tail.

9. The gaming machine of claim 1, wherein the symbols are positioned on simulated reels of a video display.

10. A method of conducting a wagering game on a gaming machine, the method comprising:
receiving a wager input;
displaying an array of symbols in a display region, the symbols indicating a randomly selected outcome of the wagering game, the randomly selected outcome being selected from a plurality of outcomes including at least one winning outcome, at least one of the symbols being an advantageous symbol that indicates the potential for completing the at least one winning outcome resulting in an award; and
animating the at least one advantageous symbol on the array as the advantageous symbol moves through the display region.

11. The method of claim 10, wherein the display region is the primary display of the gaming machine.

12. The method of claim 10, wherein the animating occurs in response to a first symbol stopping on an active payline in the display region, the winning symbol combination comprising at least the first symbol and the advantageous symbol.

13. The method of claim 10, wherein the at least one advantageous symbol includes two advantageous symbols.

14. The method of claim 10, wherein the at least one advantageous symbol is a scatter-award symbol.

15. The method of claim 10, wherein animating the at least one advantageous symbol includes enlarging the at least one advantageous symbol.

16. The method of claim 10, wherein animating the at least one advantageous symbol includes animating the background of the at least one advantageous symbol.

17. The method of claim 10, wherein animating the at least one advantageous symbol includes adding additional images on or near the at least one advantageous symbol.

18. A method of conducting a wagering game on a gaming machine, the method comprising:
receiving a wager input;
displaying a plurality of spinning reels having a plurality of symbols thereon, the symbols indicating a randomly selected outcome of the wagering game, the randomly selected outcome including at least one winning outcome indicated by a winning symbol combination having at least a first winning symbol and a second winning symbol;
stopping at least one of the reels with the first winning symbol on an active payline; and
while another of the reels is spinning, animating the second winning symbol as the second winning symbol moves adjacent to the active payline.

19. The method of claim 18, wherein the winning outcome further includes a third winning symbol, and the method further includes, in response to the second winning symbol being stopped on the active payline, animating the third winning symbol as the third winning symbol moves adjacent to the active payline.

20. The method of claim 18, wherein animating the second winning symbol includes animations selected from the group consisting of internal symbol movement changes, background symbol animation, border symbol animation, enlarged symbol animation, and sparks symbol animation.
